(19) United States
(12) Patent Application Publication
(10) Pub. No.: US 2017/0046723 A1
(43) Pub. Date: Feb. 16, 2017

(54) COMPUTER IMPLEMENTED METHOD AND COMPUTER SYSTEM FOR OBTAINING USER INFORMATION

(71) Applicant: Spota Tech Ltd., Berkshire (GB)

(72) Inventors: Joseph David Purcell, Surrey (GB); Stephen Daniel Hughes, Buckinghamshire (GB)

(21) Appl. No.: 15/235,916

(22) Filed: Aug. 12, 2016

(30) Foreign Application Priority Data
Aug. 14, 2015 (GB) 1514441.3

(51) Int. Cl. G06Q 30/02; H04L 29/08

(52) U.S. Cl. CPC G06Q 30/0201; H04L 67/306; H04L 67/18; G06Q 50/01

(57) ABSTRACT

A server implemented method and system for providing merchants with customer information by receiving customer profile data from a social network onto which a customer has logged-in using a customer's device over a network, storing the customer profile data in a storage device, generating reward data for products or services offered by merchants, the respective reward data identifying the merchants offering the respective reward, transmitting the reward data over the network to a customer's device, receiving a customer's selection of reward data for a product or service from the customer's device, receiving a message related to the product or service associated with the selected reward data from the customer's device and forwarding the message to the social network over the network for posting on the social network, storing data indicating the selection of the reward to be redeemed at the merchant by the customer; and transmitting information on the selected reward data and the stored customer profile data to a merchant's computer over the network.

### FIELD OF THE INVENTION

The present invention relates to a computer implemented method and a computer system for obtaining user information from social networks.

### BACKGROUND INFORMATION

The growth of social networks such as Facebook, Twitter, Google+ and Instagram provides a source of information on users, the use of which can avoid the need for users to enter repeatedly a significant amount of data.

In e-commerce systems it is known to target advertisements and offers to customers. There is however a need to provide an improved system to encourage customers to make purchases and to gather information from customers for merchants with a reduced user data input requirement.

### SUMMARY OF THE INVENTION

One aspect provides a server implemented method of providing merchants with customer information, the method comprising receiving customer profile data from a social network onto which a customer has logged-in using a customer's device over a network; storing the customer profile data in a storage device; generating reward data for products or services offered by merchants, the respective reward data identifying the merchants offering the respective reward; transmitting the reward data over the network to a customer's device; receiving a customer's selection of reward data for a product or service from the customer's device; receiving a message related to the product or service associated with the selected reward data from the customer's device and forwarding the message to the social network over the network for posting on the social network; storing data indicating the selection of the reward to be redeemed at the merchant by the customer; and transmitting information on the selected reward data and the stored customer profile data to a merchant's computer over the network.

Another aspect of the invention provides a computer system for providing merchants with customer information, the system comprising: a program memory storing program code; and a processor for implementing the program code stored in the program memory; wherein the program code comprises: code for controlling the processor to receive customer profile data from a social network onto which a customer has logged-in using a mobile device over a network; code for controlling the processor to store the customer profile data in a storage device; code for controlling the processor to generate reward data for products or services offered by merchants, the respective reward data identifying the merchants offering the respective reward; code for controlling the processor to transmit the reward data over the network to a customer's device; code for controlling the processor to receive a customer's selection of reward data for a product or service from the customer's device; code for controlling the processor to receive a message related to the product or service associated with the selected reward data from the customer's device and forwarding the message to the social network over the network for posting on the social network; code for controlling the processor to store data indicating the selection of the reward to be redeemed at the merchant by the customer; and code for controlling the processor to transmit information on the selected reward data

Another aspect of the invention provides a device for use by a customer to access a reward service comprising a program memory storing program code; and a processor for implementing the program code stored in the program memory; wherein the program code comprises: code for controlling the processor to log into a social network over a network to cause customer profile data to be downloaded to a reward service server; code for controlling the processor to receive reward data for products or services offered by merchants over the network from the reward service server, the respective reward data identifying the merchants offering the respective reward; code for controlling the processor to transmit a customer's selection of reward data for a product or service; code for controlling the processor to transmit a message related to the product or service associated with the selected reward data to the reward service server for the forwarding of the message to the social network over the network for posting on the social network; and code for controlling the processor to activate reward data for redemption of the reward at a merchant.

Another aspect of the invention provides a storage medium storing code for controlling a processor to log into a social network over a network to cause customer profile data to be downloaded to a reward service server; code for controlling the processor to receive reward data for products or services offered by merchants over the network from the reward service server, the respective reward data identifying the merchants offering the respective reward; code for controlling the processor to transmit a customer's selection of reward data for a product or service; code for controlling the processor to transmit a message related to the product or service associated with the selected reward data to the reward service server for the forwarding of the message to the social network over the network for posting on the social network; and code for controlling the processor to activate reward data for redemption of the reward at a merchant.

Another aspect of the invention provides a server system comprising: a plurality of application program interfaces (APIs), each API providing an interface to a respective social network; and a processor programmed to receive a user selection of at least one social network and user login information for said at least one social network from a user device, to pass on the login information to said at least one social network using a respective at least one API, to receive user profile data from the at least one social network using a respective API, and to transmit the user profile data to at least one third party server.

Another aspect of the invention provides a method comprising: a plurality of application program interfaces (APIs), each API providing an interface to a respective social network; and receiving a user selection of at least one social network and user login information for said at least one social network from a user device; passing on the login information to said at least one social network using a respective at least one application program interface (API), each API providing an interface to a respective social network; receiving user profile data from the at least one social network using a respective API; and transmitting the user profile data to at least one third party server.

### BRIEF DESCRIPTION OF THE DRAWINGS

FIG. 1 is a schematic diagram illustrating a computer system according to one embodiment;

FIG. 2 is a flow diagram illustrating the process of downloading and activating an app on a customer's mobile device according to one embodiment;

FIGS. 3a and 3b are a flow diagram illustrating the process of selecting and using a voucher to receive a reward according to one embodiment;

FIG. 4 is a flow diagram illustrating a modified process of FIGS. 3a and 3b according to another embodiment; and

FIG. 5 is a flow diagram illustrating the process of determining an influence score for a customer.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

In the following embodiments, like components are labelled with like reference numerals.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

A generalized embodiment provides a method and system addressing the technical problem of gathering data on users in computer systems without requiring the users to enter the data repeatedly. By encouraging users to permit the extraction of data on users from social networks, third parties, such as merchants are able to obtain user data without requiring the reentry of the data by users (e.g. customers), thereby reducing data entry and simplifying use of the computer devices.

In one embodiment, a server can be interfaced to at least one social network server using for example at least one respective API to enable user entered social network login data to be sent to the social network server from the server and to enable the receipt of user profile data from the at least one social network server. The user profile data can then be shared with third party servers in accordance with a selection by the user of a message originating from the third party server. The message can in one embodiment comprise an offer of a reward associated with a product or service in the form of a voucher created at the server by a merchant.

Specific embodiments will now be described with reference to the accompanying drawings.

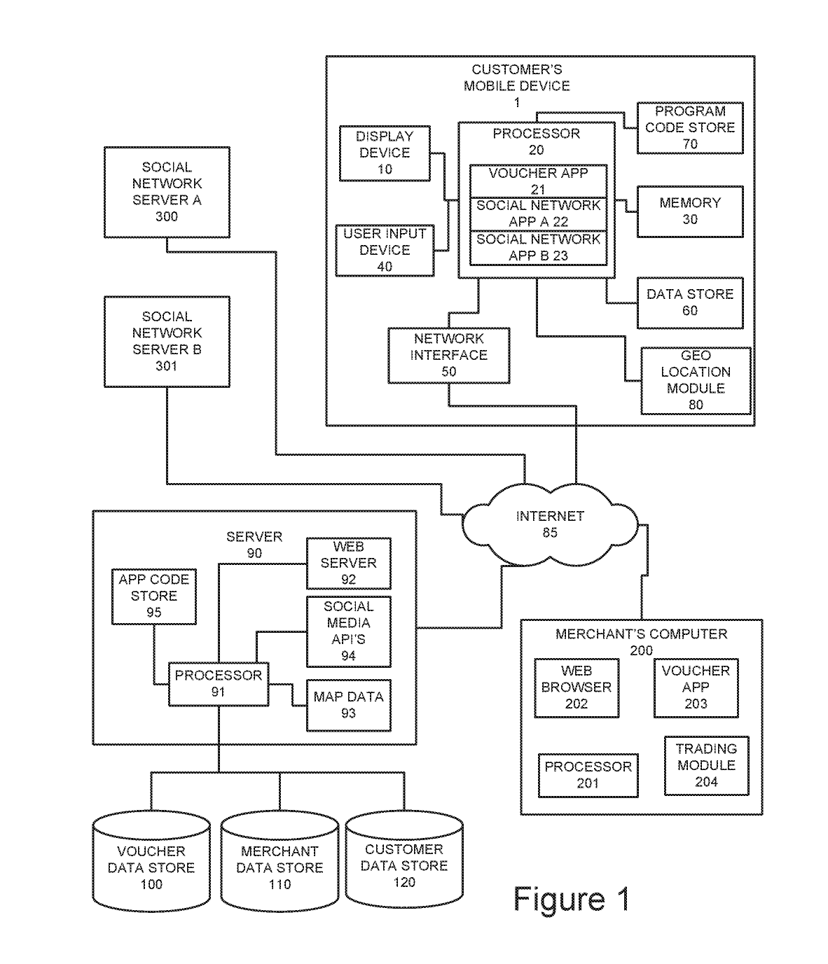

A first embodiment will be described with reference to FIGS. 1 to 3. FIG. 1 is a schematic diagram of a computing system according to one embodiment.

A customer's mobile device 1 can comprise a smart phone, tablet, laptop or any other device capable of connecting remotely to a network such as the internet 85. The customer's mobile device 1 includes a network interface for connecting the device 1 to the internet 85. The network interface can use any known form of network connection including a wired or wireless connection such as an Ethernet connection, a Wi-Fi connection, a near field wireless connection, a Bluetooth connection, or a mobile telephone connection such as 3G or 4G. A processor 20 within the device 1 reads program code from a program code store 70 and executes the code. In this embodiment, the code being executed includes a voucher app 21 to enable a customer to claim reward vouchers and two different social network apps 22 and 23, such as Facebook, Twitter, Google+ or Instagram. A volatile memory 30 is provided as working memory for use by the processor 20 during its operation. A data store 60 is provided for use by the processor 20 in storing data in the device 1. Such data can comprise social network profile data for the customer, favorites data comprising data on merchants saved as favorites by customers to enable easy access to data on the merchants, and history data comprising data on reward vouchers comprising claimed vouchers (vouchers claimed by the customer but not yet used) and expired or used vouchers which have been either used by the customer or have expired. The details of the data will be described in more detail hereinafter.

The device 1 is also provided with a display device 10 to display information to a customer and options for selection by the customer and a user input device 40 to enable the customer to enter data and selections of displayed options. The user input device 40 can comprise any form of user input device such as a pointing device e.g. mouse, pen pad or trackpad, or a touch sensitive device such as a touch screen. The display device 10 and the user input device 40 can comprise a combined touch sensitive display.

A geo location module 80 is provided in the device 1 to detect the geolocation of the device 1 and provide the location information to the processor 20.

A merchant's computer 200 is connected to the internet 85 to enable a merchant to access the web server 92 of the server 90 using a web browser 202 implemented using a processor 201. In one embodiment, the merchant can simply enter data and access data at the server 90 using the web browser 202. In another embodiment, the merchant's computer 200 includes a voucher app 203, which is implemented by the processor 201 to provide additional functionality, such as an interface to the merchant's trading module 204, which is implemented by the processor 201 to provide the trading and transaction functions for the merchant. This enables the processing of voucher data with the transaction data of the merchant to provide the merchant with additional processed information on the purchasing behaviour of customers using the vouchers. In one embodiment, the voucher app 203 receives information identifying a voucher detected in the vicinity of the merchant. The voucher is carried as voucher data by the customer's mobile device 1 and therefore the voucher identity information can be obtained by detecting the voucher using for example a bar code reading of a displayed bar code on the display device 10 of the customer's mobile device 1, by a Bluetooth, Wi-Fi, or near field wireless exchange of data between the merchant's computer 200 and the customer's mobile device 1, or Merchant entry of a voucher id code displayed on the display device 10 of the customer's mobile device 1.

A server 90 is provided connected to the internet 85 to host the reward voucher service. The server 90 includes a processor 91 to perform the processing operations on the customer profile data, the voucher data, and the merchant data as will be described in more detail hereinafter. The server includes a web server 92 to provide a web interface to merchants to enter merchant information for storage in a merchant data store 110 and to create new vouchers by entering voucher data for storage in a voucher data store 100. In order to provide an interface to each of a plurality of social network servers 300 and 301 to access user data for customers registered with social networks, an application program interface (API) 94 is provided for each social network server 300 and 301. Each API allows login data received from a customer's mobile device 1 to be passed from the server 90 to a respective social network server 300 or 301 to log into the social network and to return user profile data for the customer to the server 90 for storage in a customer data store 120.

The server 90 also includes map data 93 to enable the generation of a navigable map interface at the customer's mobile device 1 to enable the customer to select to claim a voucher from vouchers offered at locations on the map interface. The map data can be obtained from a map data source such as for example Google maps. In an alternative embodiment, the map data can be obtained directly from the map data source dynamically as the map interface is generated at the customer's mobile device 1.

The server 90 also includes an app data store 95 to store app code for transmission and installation at the customer's mobile device 1 to enable the customer's mobile device 1 to access the service at the server 90. In an alternative embodiment, the app code can be made available on any conventional app code store such as Apple's App Store.

Although the voucher data store 100, the merchant data store 110 and the customer data store 120 are shown as separate data stores, the data can be stored in any logical or physical arrangement suitable for the required data.

The following described the data structure of the data stored in the data stores 100, 110 and 120.

Voucher Data

A voucher is a voucher type as created by a merchant for their goods or services. A voucher type can be offered and claimed by many customers. The voucher data is stored in the voucher data store 100 and comprises:
Voucher ID—an unique identifier for a voucher type
Merchant ID—the unique identifier of the merchant that generated the offered voucher
Reward data—detailing the reward the customer can obtain for presenting the voucher to the merchant e.g. a free item, a fixed value item, a fixed value to spend on items, or a percentage off items
Live date and time for the offer—this is the period that the merchant wishes the voucher to be offered to customers on the system
Limit per customer—this is the limitations placed on the voucher availability to customers, e.g. one per customer per week
Voucher expiry period—this is the period that the voucher is valid after having been activated. This is typically a short period of time during which the customer can use the voucher after having activating it e.g. in the merchant's premises.
Voucher claim period—this is the period that the voucher is valid after being claimed. This period could be set by the merchant to be the same as the live date and time for the offer so that any claimed vouchers will expire when the merchant withdraws the offer.
Voucher expiry reminder period—this is a period of time before the expiry of the voucher at which the app will generate a reminder to the customer that the voucher is about to expire
Posting template text—this defines the format and some standard text for inclusion in the message to be posted on the social network(s)

Voucher Instance Data

A voucher instance is an instance of a voucher type and represents a voucher claimed at a point in time by a customer. Hence the voucher instance data links the customer to the voucher type and records the time the voucher was created along with the time the voucher was used or expires. This represents voucher state data. The voucher instance data is stored in the voucher data store 100 and comprises:
Voucher instance ID—a unique identifier for the instance of the voucher
Voucher ID—the unique identifier for the voucher of which this is an instance
Customer ID—the unique identifier for the customer to whom this voucher instance belongs
Time the voucher was claimed
Time of use (activation or actual recorded use) of the voucher
Time of expiry of the voucher

Customer Data

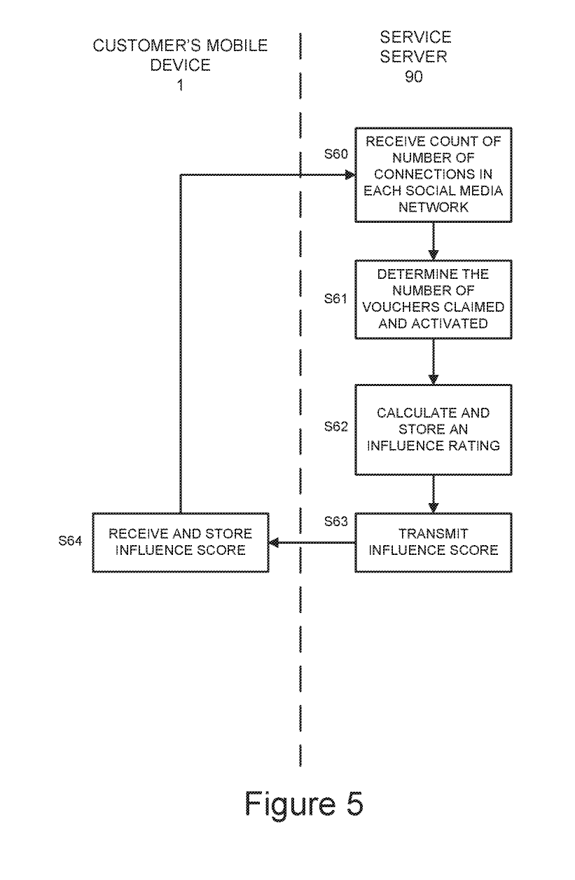

The customer data comprises all the data recorded that is unique to the customer. The customer data is stored in the customer data store 120 and comprises:
Customer ID—a unique identifier for the customer
Social network profile data—e.g. age, sex, date of birth, location, profile picture, name, number of ‘friends’ (connections) on the social network(s)
Social networks selected by the customer to post to—the URLs of the social networks such as Facebook, Instagram Google+ and Twitter to which the user is registered and allows messages to be posted to
Favorites—merchant IDs for merchants saved as favorites by customers
History—voucher instance IDs for expired and used activated vouchers and voucher instance IDs for claimed vouchers not yet activated
Influence score—the influence score can be an overall influence score and market sector based influence scores for the customer. The influence score is determined and updated for a customer based on a number of factors including social network connections for the customer. The determination and updating of the influence score is discussed hereinafter with reference to FIG. 5.

Merchant Data

The merchant data comprises all the data recorded that is unique to the merchant. The merchant data is stored in the merchant data store 110 and comprises:
Merchant ID—a unique ID for the merchant
Voucher IDs—the unique IDs for the vouchers created by and belonging to the merchant.
Merchant data—can include the merchant's logo, location, email address, opening hours, whether Wi-Fi is available in store etc. This is the information that is provided for display with the voucher on the customer's mobile device.
Budget for the service—the merchant can set a budget for the expenditure on the service to avoid overspending e.g. a £100 per month limit for a service charging £0.01 per voucher claimed by a customer.
Social network data—the merchant may belong a one of more social networks. The URL for the social network site is provided to enable the system to pull down data and even to validate the merchant
Merchant score—this is the aggregated or average score for the merchant as scored by the customers using the system

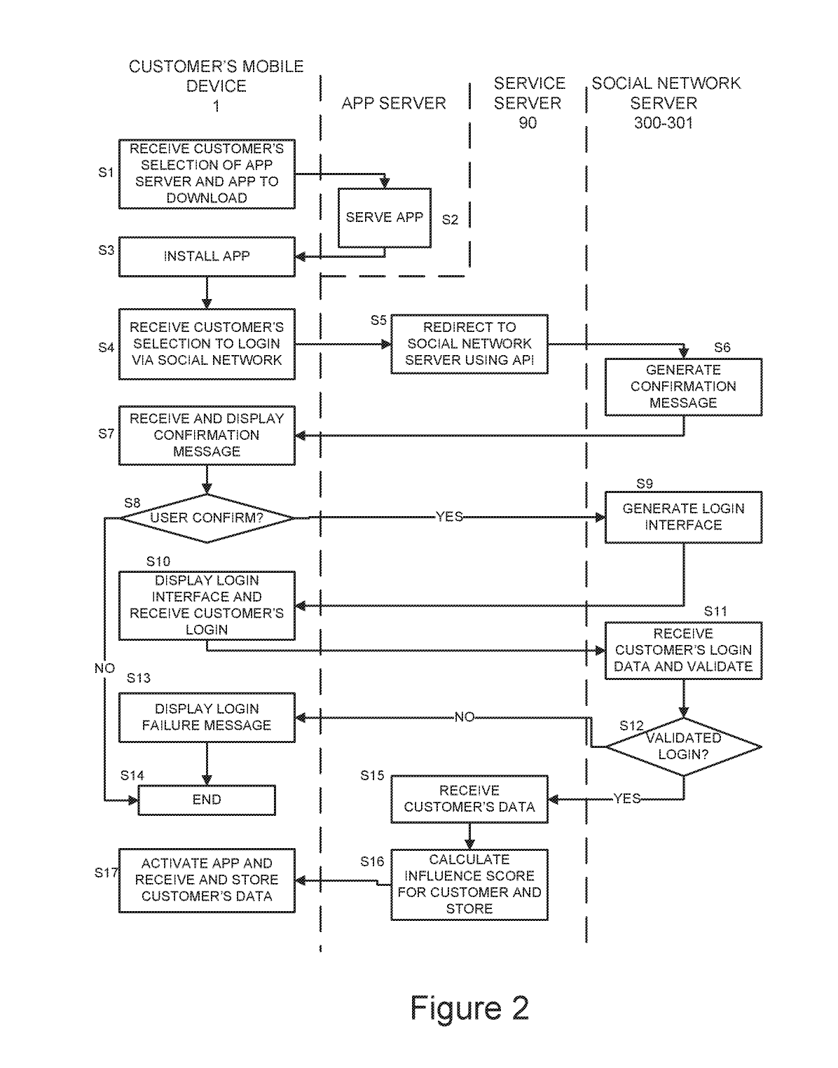

The process of installing and activating an app on a customer's mobile device 1 in accordance with one embodiment will now be described with reference to the flow diagram of FIG. 2, which illustrates the operation of computer code on the computing devices illustrated in FIG. 1.

In step S1 a customer user the customer's mobile device 1 to select an app server such as server 90 or a general well known app server such as Apple's App Store and a request to download the voucher app 21 is transmitted to the app server. The app server responds in step S2 by serving the app code, which is received and installed on the customer's mobile device 1 in step S3.

In step S4, a customer's selection to login via a social network is received, which is transmitted to the server 90 and redirected to the social network server 300 or 301 in step S5. In step S6 the social network server 300 or 301 generates a confirmation message and transmits it back to the customers mobile device 1 via the service server 90. In step S7 the message is received and displayed and a user confirmation is awaited at step S8. The confirmation message can inform the customer that they will be allowing data in their user profile on the social network site to be shared with the service and it can also inform the customer that the service will be allowed to push messages to the social network site for posting. If no user confirmation is received, the process ends at step S14. If a user confirmation is received, this is passed to the social network server 300 or 301 via the service server 90 and in step S9 the social network server 300 or 301 generates a login interface, which is transmitted to the customer's mobile device 1 via the service server 90. In step S10 the login interface is displayed and the customer's login data is received and transmitted via the service server 90 to the social network server 300 or 301. In step S11 the login data is received and validated. If the login data is not valid (step S12) a message is passed to the customer mobile device 1 for the display of a login failure message in step S13 and the process ends at step S14.

If the customer's login data is validated in step S12, user profile data is passed to the service server 90 as customer data in step S15 and this data is stored in the customer data store 120.

In step S16, a customer's influence score is calculated and stored in the customers data store 120. A customer's influence score is an indication of how influential the customer is likely to be in influencing others to visit or do business with the merchant. An overall influence score can be calculated for the customer as well as sector specific influence scores reflecting the influence of the customer in making others buy products or services in a particular business sector e.g. food and drink, DIY or domestic electrical equipment. The factors that can be used to calculate the customer's influence score are:
Number of social network connections
The activity of the user on the social networks—inactivity can cause a decay in the influence score
The activity of the user on the service e.g. how many vouchers are claimed and how many are activated—inactivity can cause a decay in the influence score
How successful shared links are on the social network site—when a message is posted by the customer to claim a voucher, a link to the merchant or to claim a voucher can be provided in the message.
Business activity generated by the claimed voucher—transactions can be recorded and linked to vouchers at the merchants and links between transactions influenced by a customer can be identified from the recorded transaction and voucher data at the merchant.

The influence score or scores calculated in step S16 is or are transmitted to the customer's mobile device 1 along with other customer data and the customer data is stored and the app activated in step S17. The app is now ready to claim vouchers offered by merchants using the service.

The process of FIG. 2 illustrates the method to activate for a first time or after the user has logged off from the app. The service uses a default social network site such as Facebook to provide the authentication process for the user to avoid requiring the user to remember another set of login credentials.

The app can be provided with a user maintenance interface section that enables a user to log into or log off from social network sites. The logging into social network sites associates the sites with the service and the service receives a token for use by the APIs for authenticated exchange of data between the server 90 and the social network servers 300 and 301. Thus a user can set up a default set of their social network sites associated with the service for the posting of messages to the sites. For each message, the user can deselect sites from the default list as will be described below.

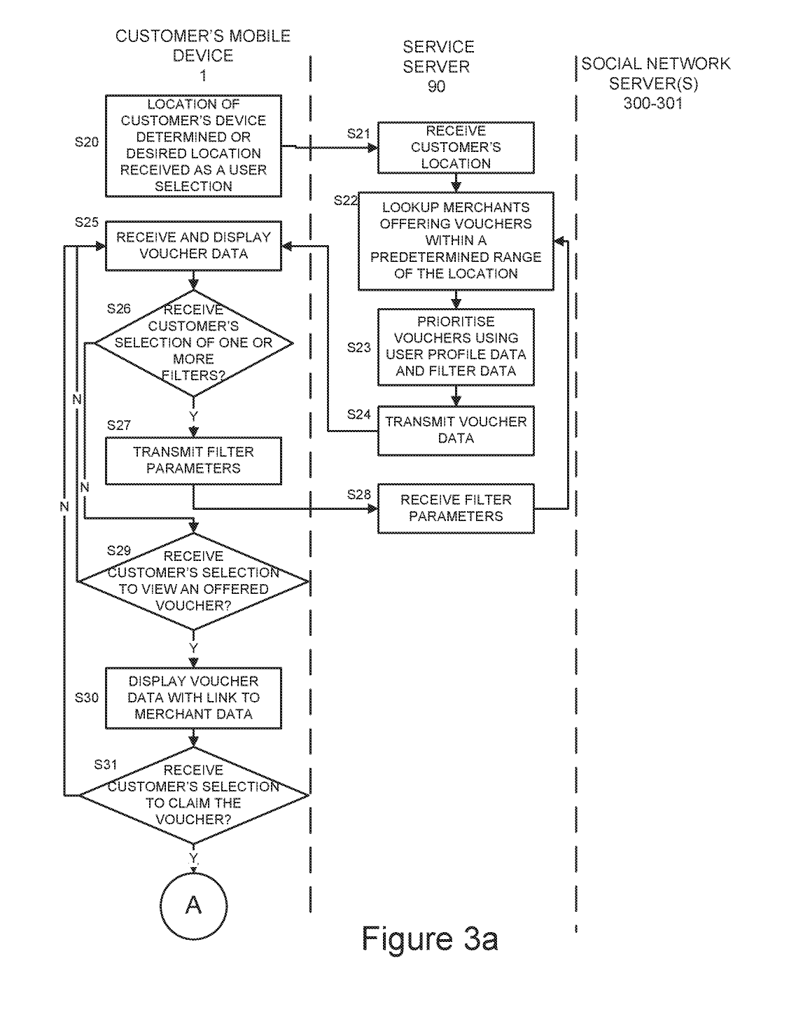

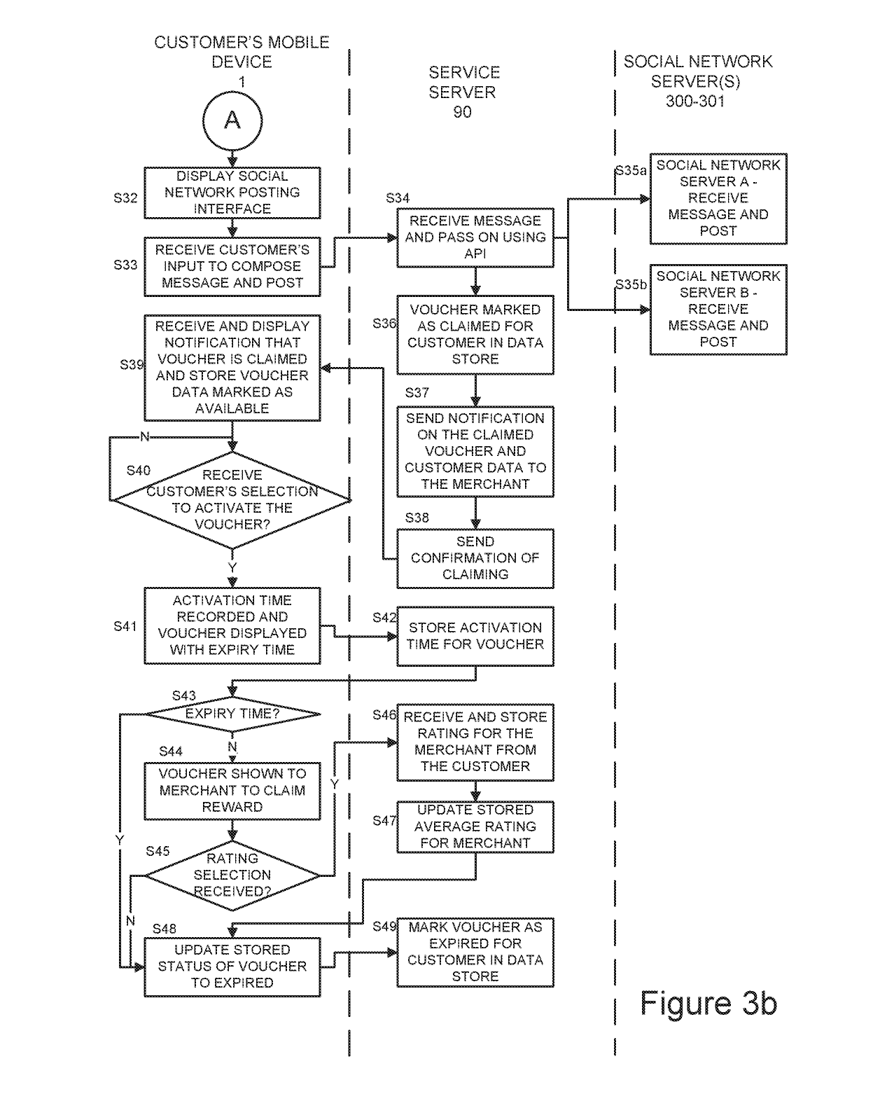

The process of claiming vouchers offered by merchants according to one embodiment will now be described with reference to the flow diagram of FIGS. 3a and 3b, which illustrates the operation of computer code on the computing devices illustrated in FIG. 1.

In step S20 the location of the device 1 is determined using the go location module 80 or a desired location is received as a customer selection or input on the device 1 and this location data is transmitted to the service server 90 where it is received in step S21. In step S22 the voucher data store 100 is queried to identify current vouchers being offered by merchants which have locations within a predetermined range of the customer's location. The list of vouchers is then sorted to prioritize the vouchers using user profile data or customer data and any filter data entered by the customer in step S23. The filters can comprise such filters as:
Order by newest or oldest offers
Offer category e.g. foods and drink, clothing, travel etc
Distance from customers location e.g. 100 m, 500 m 1 km etc
Number of offered vouchers to be sent e.g. 20, 50, 100, unlimited

In step S24 the voucher data is transmitted to the customer's device 1, where it is received and displayed in step S25. The vouchers can be displayed in any convenient form and this display form may be selectable by the customer. For example, the vouchers could be displayed as an ordered list in the order determined in step S23. Alternatively, the vouchers could be rendered onto a locations on a map. The information on each voucher that is displayed can comprise brief information on the reward offered by the voucher for the list view of the vouchers and, for the map view of the vouchers, an indication of the type of reward being offered e.g., something is free, 10% off, 50% off etc.

The process then waits to determine whether the customer selects to filter the voucher results by entering one or more filters in step S26. The selected filter parameters are transmitted to the service server 90 in step S27 and in step S28 the filter parameters are received at the service server 90 and applied in the process by returning the process to step S22.

If the customer does not select one or more filters in step S26, in step S29 the process waits for the customer to select to claim an offered voucher. If no selection is made the process returns to step S25 to cycle and wait for a selection of a filter or a voucher. If a voucher is selected in step S29, in step S30 the voucher data is displayed with a link to the merchant that can be selected to download more information on the merchant or activate a web browser and open the merchant's web page. The voucher data displayed can include the name and location of the merchant, the rating of the merchant, the details of the offer for the product or service and optionally a voucher ID or code. The display device will also display an option to select to claim the voucher.

In step S31 the process waits for the customer to decide whether they wish to claim the voucher. If they do not the process returns to step S25 to await a customer selection of a filter of a voucher. If the customer selects to claim the voucher in step S31, the display device displays a social network posting interface in step S32. This interface provides a template for inputting text to compose a message to be posted on at least one social network site of which the customer is a member. The template can provide restrictions on the input that a customer can make. For example, to avoid the input of profane or defamatory text, the inputs to compose the message may be limited to emojis. The interface also displays a plurality of possible social network sites to which the customer can select to post. The list of social network sites is a list of the social network sites of which the customer is a member. The interface enables the customer to select and deselect social network sites to which the message is to be posted in step S33. Also, the interface can allow the customer to take picture to accompany the text and form part of the message to be posted. The template can include predefined text when allowed by the social network sites, such as “Saw an offer for a free coffee” and can include a tag such as “Going to Joe's Café” or “At Joe's Café”. Once the customer has composed the message and selected the social network sites, the interface provides the option to poste the message. The posted message is transmitted to the service server 90 in step S34, which receives the message and passes it onto the identified social network servers 300 and 301 in step S34. In steps S35a and S35b the social network servers 300 and 301 receive and post the message.

In step S36 a voucher instance is created to mark a voucher as claimed by a customer in the voucher data store 100. In step S37 a notification is sent to the merchant to infirm the merchant that a voucher has been claimed and to provide data on the voucher and the customer. In one embodiment, the notification can be by an email to the merchant. The email contains details of the voucher claimed and customer profile data. This data is extracted from the data store and used by the processor to compose an email to be sent to the merchant. In another embodiment, an SMS message could be composed and sent to a mobile telephone number stored for the merchant. In another embodiment, where the merchant's computer 200 has the voucher app 203 installed, the notification can be sent by a communication from the server 90 to the voucher app 203 and the voucher app 203 can store or access the data related to the voucher instance and generate an alert to the merchant that a voucher has been claimed by a customer. The merchant can access and display the voucher instance data and the customer data locally on the merchant's computer 200 when it is downloaded from the server 90 or the voucher app 203 on the merchant's computer 200 can access the data stores 100 and 120 to retrieve the data.

Confirmation of the claiming of the voucher by the customer upon successful posting of the message and notification of the merchant is then sent to the customer's device 1 by the server 90 in step S38. In step S39 the customer's device receives and displays the notification and stores data on the claimed voucher marked as available for use.

The process then waits at step S40 for the reception of a customer's selection to activate a voucher from displayed claimed vouchers. The claimed vouchers can be displayed as a list or rendered onto a map to show the location of the merchant offering the claimed reward. When a customer's selection is received, in step S41 the time and date of the selection is recorded and the voucher is displayed on the customer's device 1 with a calculated expiry time. The expiry time can be calculated based on the time the voucher was activated and the expiry period recorded for the voucher type by the merchant. The expiry period is in one embodiment a short period much less than a day, such as an hour. The expiry period can be shown as a timer counting down to expiry. The voucher display can in one embodiment include details of the offered reward, the merchant and details of the customer, which can include a copy of the profile picture downloaded from the social media network as part of the user profile data. The activation time is transmitted to the server 90 and stored for the voucher instance in the voucher data store 100 in step S42.

The process then monitors the expiry time of the voucher in step S43 and if the voucher has expired without being used, in step S48 the voucher data stored at the customer's device 1 is updated for the voucher instance to expired and in step S49 the server 90 either receives a notification of the status from the customer's computer or determines from its own timing that the voucher has not been used during the voucher expiry period and the voucher instance is marked in the voucher data store 100 as expired.

If the voucher is presented to the merchant during the expiry period (step S44), the merchant can provide the customer with the reward as part of a transaction with the customer. In this embodiment, the redemption of the reward simply comprises showing the displayed voucher to the merchant. The merchant can validate that the voucher is being presented by the correct customer from the profile picture displayed as part of the voucher data. This provides a simple method of issuing vouchers to users without requiring the adoption and installation of any new technology by the merchant for validating the presented voucher. The merchant can simply record in their trading and transaction system manually entered details related to the transaction and voucher use.

Once the voucher has been presented to the merchant in step S44, the customer has the option to input a rating selection in step S45. Such a selection can for example be a number from 1 to 10 or a star rating from 1 to 5 stars. If the customer elects not to enter a rating selection, in step S48, the stored status of the voucher instance is updated to expired and in step S49 the server 90 receives a notification of the status from the customer's computer and the voucher instance is marked in the voucher data store 100 as expired. It should be noted that in this embodiment, no separate used status is stored, since there has been no response from the user and there is no ability at the merchant to uniquely identify and record the use of the voucher.

If in step S45 the customer elects to make a rating selection the rating selection is transmitted to the server 90 where it is received and stored for the merchant in the voucher data store 100 in step S46. In step S47 the received score is used to calculate a new running average score for the merchant and the average score for the merchant is stored in the merchant data store 110. The process of calculating the merchant score can be a simple averaging based on the total score divided by the number of customers selecting a score. Alternatively, a more complex scoring process can be used. For example, the score could be weighted dependent upon customer data such as the influence score for the customer. A customer with a higher influence score may be given a higher weighting in the calculation of the average score for the merchant.

Thus, the process for claiming, activating and using vouchers has been described according to one embodiment.

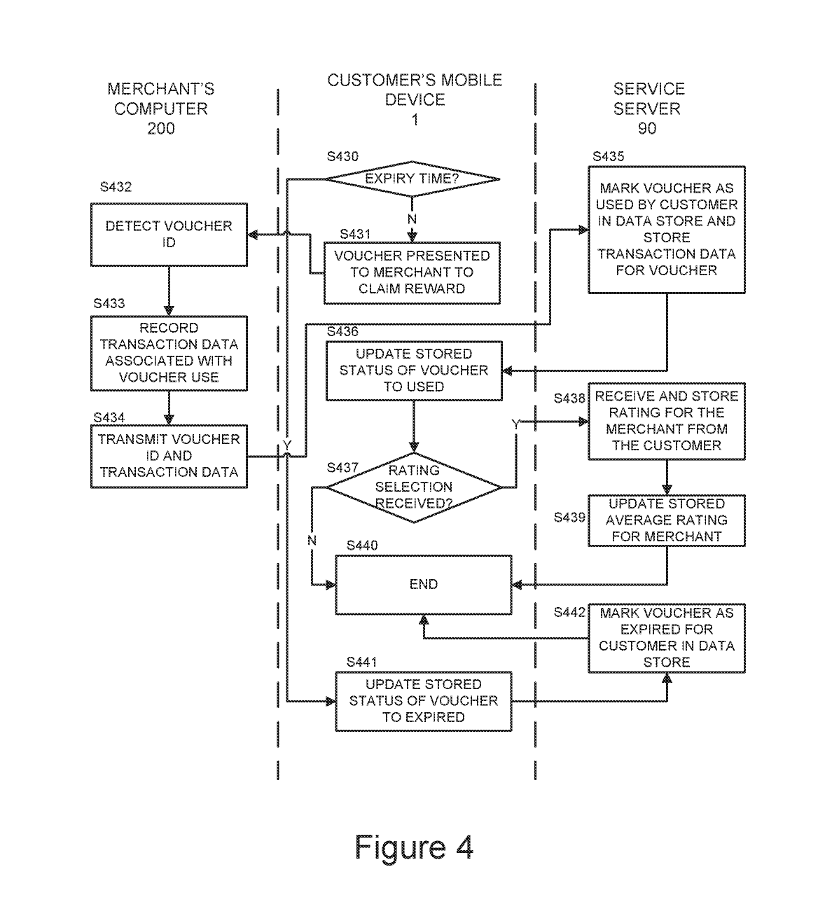

An alternative embodiment, which is a modification of the process illustrated in FIGS. 3a and 3b will now be described with reference to the flow diagram of FIG. 4, which is a partial from diagram to replace steps S43 to S49 of FIG. 3b. The process of this embodiment is the same as for the previous embodiment from step S20 to step S42.

In the customer's mobile device 1, the process monitors the expiry time of the voucher in step S430 and if the voucher has expired without being used, in step S441 the voucher data stored at the customer's device 1 is updated for the voucher instance to expired and in step S442 the server 90 either receives a notification of the status from the customer's computer or determines from its own timing that the voucher has not been used during the voucher expiry period and the voucher instance is marked in the voucher data store 100 as expired. The process then ends at step S440.

If the voucher has not expired in step S430, in step S431 the voucher is presented to the merchant to claim the reward. In this embodiment, the voucher instance ID or a code related to or associated with the voucher instance ID is exchanged with the merchant. This can be achieved in step S432 by the detection of the voucher ID by the merchant's computer using any known technology such as by displaying a bar code or a QR code encoding the voucher ID, which can be read by a reader device of the merchant's computer, or by simply displaying a human readable code that the merchant can enter into their computer or point of sale device. Alternatively, the voucher ID could be transmitted to the merchant's computer wirelessly using Bluetooth, Wi-Fi or near field technology. The time of use of the voucher is also recorded and stored as part of the voucher status data.

In step S433 the transaction data for the transaction by the customer using the voucher is recorded with the voucher ID by the merchant's computer and the voucher ID and status data and transaction data is transmitted to the service server 90 in step S434. In step S435 the voucher is marked as used in the voucher data store 100 by the service server 90 and the transaction data is stored in the merchant data store 110. In this way, transaction data associated with voucher use can be recorded and processed to provide business information to the merchant.

In step S436 the used status of the voucher instance is transmitted to the customers device 1 and the stored status of the voucher is updated to used. In step S437, a customer can elect to select a rating for the merchant to rate their experience in their dealing with the merchant. If they do not the process ends at step S440.

If in step S437 the customer elects to make a rating selection the rating selection is transmitted to the server 90 where it is received and stored for the merchant in the voucher data store 100 in step S438. In step S439 the received score is used to calculate a new running average score for the merchant and the average score for the merchant is stored in the merchant data store 110. The process of calculating the merchant score can be a simple averaging based on the total score divided by the number of customers selecting a score. Alternatively, a more complex scoring process can be used. For example, the score could be weighted dependent upon customer data such as the influence score for the customer. A customer with a higher influence score may be given a higher weighting in the calculation of the average score for the merchant.

Thus, in this embodiment, the use of the voucher ID enables the use of the voucher to be associated with a transaction and its use tracked and recorded both by the merchant's computer 200 and by the service server 90. This provides the merchant with significant data on the customer, and their transactions as well as their use of the vouchers.

The process for maintaining the influence score current for customers will now be described with reference to the flow diagram of FIG. 5, which is implemented in software by the server 90. As discussed herein above with reference to FIG. 2, when a customer installs and activates the app an initial influence score is calculated for them in step S16. The influence score is however not a static parameter and is constantly updated.

In step S60 the number of connections the customer has in each social network that they have associated with the service is received as part of the user profile data. Such data is periodically received from the social network sites using the APIs. The number of vouchers that have been claimed and activated by the customer is determined in step S61. The number of network connections and the number of vouchers claims and activated is used in step S62 to calculate and store an influence score for the customer. The score is then transmitted to the customer's device 1 in step S63 and in step S64 the influence score is received and stored at the customer's device 1.

The number of network connections is an indicator of how well connected the customer is and hence more connections indicates that they hay have a higher influence. The score is calculated accordingly. Customers that claim a lot of vouchers are active on the service and hence can have a higher influence by the high number of postings generated by the service on their feeds on the social network sites. The score is calculated accordingly. Customers that claim a lot of vouchers but do not use them are not providing the merchants with business and hence, the influence score for customers that claim a lot of vouchers but do not activate or use them can be reduced.

An additional factor that can be used in the calculation of the influence score is transaction data. Customers that enter into high value transactions provide good business to the merchants and hence their influence score can be increased accordingly. Also, postings on the social network sites can include a link for others to select to receive similar rewards as the customer. Such rewards can be obtained by the new customer upon installation and activation of the app on their device. The number of such referred vouchers can be used to increase the influence score.

The influence rating can be determined as a whole or on a sector by sector basis, so that a customer can have an overall influence rating and a sector rating. For example, a customer might have a high voucher use for food and drink but a low voucher use for clothing, and hence their influence score for food and drink would be higher than for clothing.

A merchant can access the service by a web access or using a bespoke application such as the voucher app 203 on the merchant's computer 200 in the embodiment of FIG. 1, to create and store vouchers. Vouchers can be created that are targeted to customers having certain parameters such as a certain age, sex or influence score. In this way the process of steps S22 and S23 for example can use the data stored for the voucher which defines certain customer requirements to determine which vouchers to offer to the customer. Merchants can also withdraw vouchers before their set expiry period. The vouchers can be withdrawn generally or specific voucher instances can be withdrawn for customers with whom the merchant does not wish to trade.

Once a merchant has traded with a customer and the merchant has therefore gained information on the customer, the merchant can send vouchers and communications directly to the customer. These can be targeted based on the customer data.

The service operated by the service server records all vouchers offered as general vouchers and voucher instances and therefore the merchant can be charges for the service on a voucher by voucher basis. There can be one charge for claimed vouchers and another charge for activated or used vouchers. These charges can be recorded in the merchant data store 110 by the server 90 for billing the merchant periodically.

In one embodiment, the customer may also be provided with the option to post a further message using the voucher app 21 after having completed the transaction to provide an after service response on the social network sites. The customer may be offered a bonus voucher for doing this. The process require the display of an interface by the customer's device to offer the bonus voucher and to enable the input of the message, the forwarding of the message for posing by the server 90 using the APIs, and the updating of the status of the voucher as claimed.

Although in the described embodiment, the customer's device 1 is a mobile, device, in an alternative embodiment the customer's device can comprise any non-mobile computing device such as a desktop computer. If the device is not mobile, it does not have a geo location device. Instead, location information can be input by the user for the purposes of enabling the service to provide vouchers based on a location received from the customer's device. A customer may use a non-mobile device in order to claim a voucher, which is recorded as claimed for the customer at the server 90. In order to use of redeem the voucher, the customer is required to use a mobile device in order to show the voucher to the merchant or to have the voucher electronically detected by a merchant system automatically. In an alternative embodiment for an e-commerce merchant having no physical store (no ‘bricks and mortar store’), the use or redemption of the voucher can be by way of the input of a voucher code at the point of purchase of the goods or service. The voucher code can be a code generic to the voucher generate by the merchant e.g. “Coffee/July15” and hence usable by any customer, or it can be a voucher code unique to a voucher instance, i.e. unique to a voucher claimed by a customer, e.g. “AX1H7F9”. The use of the generic voucher code is simple but does not allow a unique relationship with the customer to be recorded (i.e. a transaction), whereas the use of the unique voucher instance code allows the voucher use to be identified as coming from a customer and related to an offer from a merchant.

The embodiments provide a method of providing customer data to merchants without requiring the customers to enter the data. In order to obtain the information, merchants need to create voucher data offering rewards to customers when they transact with the merchant. The data is obtained by the service from one or more social networks of which the customer is a member and the data is sent to the merchant when a customer selects a voucher. In this way, the merchant receives information on a prospective customer for their goods or services in advance of the prospective customer transacting with the merchant using the voucher. The receipt of advanced customer data enables the merchant to provide an enhanced transaction experience for the customer. This can be simply by the provision of a more personalized service in person in a bricks and mortar store or on a web interface in an e-commerce store, such as welcoming the customer with their name, and offering them additional products or services based on the customer information. In an embodiment in which an e-commerce merchant offers vouchers, since the e-commerce merchant does not have a bricks and mortar location, when a customer enters location information such as in step S20 of FIG. 3a, the process of looking up vouchers for e-commerce merchants will not involves the use of location data for the merchant. The location data could be used by the e-commerce merchant as an indicator of a location or region to which they are prepared to deliver a product or service. Alternatively or in addition, no location data may be provided with the voucher data and hence vouchers for such e-commerce merchants are determined based on customer data, such as age, user preferences or where available buying history data for previous transactions with the merchant or a number of merchants. Thus, the vouchers offered to the customer that can be selected and claimed can be determined without any voucher location parameters.

In the above described embodiments, the customer's device stored data associated with the voucher and the customer. Such data is synchronized with data store 100, and 120 by the server 90. Hence, in an alternative embodiment, no data or limited data need be stored at the customer's device and any data to be displayed or processed at the customer's device can be retrieved from data stores 100 and 120 by the server and any input or processed data can be saved to the data stores 100 and 120 by the server 90.

The following numbered paragraphs is a description of some generalized embodiments. Any embodiment can be used in combination with any other embodiment.

1. A server implemented method of providing merchants with customer information, the method comprising:

receiving customer profile data from a social network onto which a customer has logged-in using a customer's device over a network;

storing the customer profile data in a storage device;

generating reward data for products or services offered by merchants, the respective reward data identifying the merchants offering the respective reward;

transmitting the reward data over the network to a customer's device;

receiving a customer's selection of reward data for a product or service from the customer's device;

receiving a message related to the product or service associated with the selected reward data from the customer's device and forwarding the message to the social network over the network for posting on the social network;

storing data indicating the selection of the reward to be redeemed at the merchant by the customer; and

transmitting information on the selected reward data and the stored customer profile data to a merchant's computer over the network.

2. A method according to embodiment 1, wherein customer profile data is received from a plurality of social networks onto which the customer has logged-in using the customer's device.

3. A method according to embodiment 1 or embodiment 2, including receiving social network login data from the customer's device and forwarding the social network login data to the social network.

4. A method according to any preceding embodiment, including calculating an influence score for the customer using data on social network connections in the customer profile data, and using the influence score in the generation of the reward data transmitted to the customer.

5. A method according to embodiment 4, wherein the influence score is calculated using stored data on previous selections of rewards made by the customer

6. A method according to any preceding embodiment, including receiving location data from the customer's device, wherein the reward data transmitted to the customer's device is selected using the location data.

7. A method according to any preceding embodiment, including receiving redemption data on the redemption of the reward by the customer from a merchant's computer, and storing the redemption data.

8. A computer system for providing merchants with customer information, the system comprising:

a program memory storing program code; and

a processor for implementing the program code stored in the program memory;

wherein the program code comprises:

code for controlling the processor to receive customer profile data from a social network onto which a customer has logged-in using a customer's device over a network;

code for controlling the processor to store the customer profile data in a storage device;

code for controlling the processor to generate reward data for products or services offered by merchants, the respective reward data identifying the merchants offering the respective reward;

code for controlling the processor to transmit the reward data over the network to a customer's device;

code for controlling the processor to receive a customer's selection of reward data for a product or service from the customer's device;

code for controlling the processor to receive a message related to the product or service associated with the selected reward data from the customer's device and forwarding the message to the social network over the network for posting on the social network;

code for controlling the processor to store data indicating the selection of the reward to be redeemed at the merchant by the customer; and

code for controlling the processor to transmit information on the selected reward data and the stored customer profile data to a merchant's computer over the network.

9. A system according to embodiment 8, wherein customer profile data is received from a plurality of social networks onto which the customer has logged-in using the mobile device.

10. A system according to embodiment 8 or embodiment 9, wherein the code for controlling the processor includes code for controlling the processor to receive social network login data from the customer's device and forwarding the social network login data to the social network.

11. A system according to any one of embodiments 8 to 10, wherein the code for controlling the processor includes code for controlling the processor to calculate an influence score for the customer using data on social network connections in the customer profile data, and using the influence score in the generation of the reward data transmitted to the customer.

12. A system according to embodiment 11, wherein the influence score is calculated using stored data on previous selections of rewards made by the customer.

13. A system according to any one of embodiments 8 to 12, wherein the code for controlling the processor includes code for controlling the processor to receive location data from the customer's device, wherein the reward data transmitted to the customer's device is selected using the location data.

14. A system according to any one of embodiments 8 to 13, wherein the code for controlling the processor includes code for controlling the processor to receive redemption data on the redemption of the reward by the customer from a merchant's computer, and storing the redemption data.

15. A mobile device for use by a customer to access a reward service comprising

a program memory storing program code; and

a processor for implementing the program code stored in the program memory;

wherein the program code comprises:

code for controlling the processor to log into a social network over a network to cause customer profile data to be downloaded to a reward service server;

code for controlling the processor to receive reward data for products or services offered by merchants over the network from the reward service server, the respective reward data identifying the merchants offering the respective reward;

code for controlling the processor to transmit a customer's selection of reward data for a product or service;

code for controlling the processor to transmit a message related to the product or service associated with the selected reward data to the reward service server for the forwarding of the message to the social network over the network for posting on the social network; and

code for controlling the processor to activate reward data for redemption of the reward at a merchant.

16. A storage medium storing:

code for controlling a processor to log into a social network over a network to cause customer profile data to be downloaded to a reward service server;

code for controlling the processor to receive reward data for products or services offered by merchants over the network from the reward service server, the respective reward data identifying the merchants offering the respective reward;

code for controlling the processor to transmit a customer's selection of reward data for a product or service;

code for controlling the processor to transmit a message related to the product or service associated with the selected reward data to the reward service server for the forwarding of the message to the social network over the network for posting on the social network; and

code for controlling the processor to activate reward data for redemption of the reward at a merchant.

17. A method of transmitting:

code for controlling the processor to receive customer profile data from a social network onto which a customer has logged-in using a customer's device over a network;

code for controlling the processor to store the customer profile data in a storage device;

code for controlling the processor to generate reward data for products or services offered by merchants, the respective reward data identifying the merchants offering the respective reward;

code for controlling the processor to transmit the reward data over the network to a customer's device;

code for controlling the processor to receive a customer's selection of reward data for a product or service from the customer's device;

code for controlling the processor to receive a message related to the product or service associated with the selected reward data from the customer's device and forwarding the message to the social network over the network for posting on the social network;

code for controlling the processor to store data indicating the selection of the reward to be redeemed at the merchant by the customer; and

code for controlling the processor to transmit information on the selected reward data and the stored customer profile data to a merchant's computer over the network.

18. A server system comprising:

a plurality of application program interfaces (APIs), each API providing an interface to a respective social network; and

a processor programmed to receive a user selection of at least one social network and user login information for said at least one social network from a user device, to pass on the login information to said at least one social network using a respective at least one API, to receive user profile data from the at least one social network using a respective API, and to transmit the user profile data to at least one third party server.

19. A server according to embodiment 18, wherein the third party servers comprise merchant servers for merchants offering rewards for the user profile information.

20. A method comprising:

a plurality of application program interfaces (APIs), each API providing an interface to a respective social network; and

receiving a user selection of at least one social network and user login information for said at least one social network from a user device;

passing on the login information to said at least one social network using a respective at least one application program interface (API), each API providing an interface to a respective social network;

receiving user profile data from the at least one social network using a respective API; and

transmitting the user profile data to at least one third party server.

21. A method according to embodiment 20, wherein the third party servers comprise merchant servers for merchants offering rewards for the user profile information.

Another aspect provides a storage medium storing computer code for controlling a computer to carry out the method. Embodiments can be implemented in programmable digital logic that implements computer code. The code can be supplied to the programmable logic, such as a processor or microprocessor, on a storage medium, such as a solid-state memory, magnetic media (hard disk drive), or optical media (Compact disc (CD) or digital versatile disc (DVD)).

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A server implemented method of providing merchants with customer information, the method comprising:
receiving customer profile data from a social network onto which a customer has logged-in using a customer's device over a network;
storing the customer profile data in a storage device;
generating reward data for products or services offered by merchants, the respective reward data identifying the merchants offering the respective reward;
transmitting the reward data over the network to a customer's device;
receiving a customer's selection of reward data for a product or service from the customer's device;
receiving a message related to the product or service associated with the selected reward data from the customer's device and forwarding the message to the social network over the network for posting on the social network;
storing data indicating the selection of the reward to be redeemed at the merchant by the customer; and
transmitting information on the selected reward data and the stored customer profile data to a merchant's computer over the network.

2. A method according to claim 1, wherein customer profile data is received from a plurality of social networks onto which the customer has logged-in using the customer's device.

3. A method according to claim 1, including receiving social network login data from the customer's device and forwarding the social network login data to the social network.

4. A method according to claim 1, including calculating an influence score for the customer using data on social network connections in the customer profile data, and using the influence score in the generation of the reward data transmitted to the customer.

5. A method according to claim 4, wherein the influence score is calculated using stored data on previous selections of rewards made by the customer

6. A method according to claim 1, including receiving location data from the customer's device, wherein the reward data transmitted to the customer's device is selected using the location data.

7. A method according to claim 1, including receiving redemption data on the redemption of the reward by the customer from a merchant's computer, and storing the redemption data.

8. A computer system for providing merchants with customer information, the system comprising:
a program memory storing program code; and
a processor for implementing the program code stored in the program memory;
wherein the program code comprises:
code for controlling the processor to receive customer profile data from a social network onto which a customer has logged-in using a customer's device over a network;
code for controlling the processor to store the customer profile data in a storage device;
code for controlling the processor to generate reward data for products or services offered by merchants, the respective reward data identifying the merchants offering the respective reward;
code for controlling the processor to transmit the reward data over the network to a customer's device;
code for controlling the processor to receive a customer's selection of reward data for a product or service from the customer's device;
code for controlling the processor to receive a message related to the product or service associated with the selected reward data from the customer's device and forwarding the message to the social network over the network for posting on the social network;
code for controlling the processor to store data indicating the selection of the reward to be redeemed at the merchant by the customer; and
code for controlling the processor to transmit information on the selected reward data and the stored customer profile data to a merchant's computer over the network.

9. A system according to claim 8, wherein customer profile data is received from a plurality of social networks onto which the customer has logged-in using the customer's device.

10. A system according to claim 8, wherein the code for controlling the processor includes code for controlling the processor to receive social network login data from the customer's device and to forward the social network login data to the social network.

11. A system according to claim 8, wherein the code for controlling the processor includes code for controlling the processor to calculate an influence score for the customer using data on social network connections in the customer profile data, and using the influence score in the generation of the reward data transmitted to the customer.

12. A system according to claim 11, wherein the influence score is calculated using stored data on previous selections of rewards made by the customer.

13. A system according to claim 8, wherein the code for controlling the processor includes code for controlling the processor to receive location data from the customer's device, wherein the reward data transmitted to the customer's device is selected using the location data.

14. A system according to claim 8, wherein the code for controlling the processor includes code for controlling the processor to receive redemption data on the redemption of the reward by the customer from a merchant's computer, and storing the redemption data.

15. A device for use by a customer to access a reward service comprising
a program memory storing program code; and
a processor for implementing the program code stored in the program memory;
wherein the program code comprises:
code for controlling the processor to log into a social network over a network to cause customer profile data to be downloaded to a reward service server;
code for controlling the processor to receive reward data for products or services offered by merchants over the network from the reward service server, the respective reward data identifying the merchants offering the respective reward;
code for controlling the processor to transmit a customer's selection of reward data for a product or service;
code for controlling the processor to transmit a message related to the product or service associated with the selected reward data to the reward service server for the forwarding of the message to the social network over the network for posting on the social network; and
code for controlling the processor to activate reward data for redemption of the reward at a merchant.

16. A storage medium storing:
code for controlling a processor to log into a social network over a network to cause customer profile data to be downloaded to a reward service server;
code for controlling the processor to receive reward data for products or services offered by merchants over the network from the reward service server, the respective reward data identifying the merchants offering the respective reward;
code for controlling the processor to transmit a customer's selection of reward data for a product or service;
code for controlling the processor to transmit a message related to the product or service associated with the selected reward data to the reward service server for the forwarding of the message to the social network over the network for posting on the social network; and
code for controlling the processor to activate reward data for redemption of the reward at a merchant.

17. A method of transmitting:
code for controlling a processor to log into a social network over a network to cause customer profile data to be downloaded to a reward service server;
code for controlling the processor to receive reward data for products or services offered by merchants over the network from the reward service server, the respective reward data identifying the merchants offering the respective reward;
code for controlling the processor to transmit a customer's selection of reward data for a product or service;
code for controlling the processor to transmit a message related to the product or service associated with the selected reward data to the reward service server for the forwarding of the message to the social network over the network for posting on the social network; and
code for controlling the processor to activate reward data for redemption of the reward at a merchant.

18. A server system comprising:
a plurality of application program interfaces (APIs), each API providing an interface to a respective social network; and
a processor programmed to receive a user selection of at least one social network and user login information for said at least one social network from a user device, to pass on the login information to said at least one social network using a respective at least one API, to receive user profile data from the at least one social network using a respective API, and to transmit the user profile data to at least one third party server.

19. A server according to claim 16, wherein the third party servers comprise merchant servers for merchants offering rewards for the user profile information.

20. A method comprising:
a plurality of application program interfaces (APIs), each API providing an interface to a respective social network; and
receiving a user selection of at least one social network and user login information for said at least one social network from a user device;
passing on the login information to said at least one social network using a respective at least one application program interface (API), each API providing an interface to a respective social network;
receiving user profile data from the at least one social network using a respective API; and
transmitting the user profile data to at least one third party server.

21. A method according to claim 18, wherein the third party servers comprise merchant servers for merchants offering rewards for the user profile information.

22. A non-transient storage medium storing:
code for controlling the processor to generate reward data for products or services offered by merchants, the respective reward data identifying the merchants offering the respective reward;
code for controlling the processor to transmit the reward data over the network to a customer's device;
code for controlling the processor to receive a customer's selection of reward data for a product or service from the customer's device;
code for controlling the processor to receive a message related to the product or service associated with the selected reward data from the customer's device and forwarding the message to the social network over the network for posting on the social network;
code for controlling the processor to store data indicating the selection of the reward to be redeemed at the merchant by the customer; and
code for controlling the processor to transmit information on the selected reward data and the stored customer profile data to a merchant's computer over the network.
